(19) United States
(12) Patent Application Publication
(10) Pub. No.: US 2026/0255334 A1
(43) Pub. Date: Aug. 27, 2026

(54) JOINT SENSING METHOD AND RELATED USER EQUIPMENT FOR ORTHOGONAL FREQUENCY DOMAIN MULTIPLEXING COMMUNICATION SYSTEM

(71) Applicant: MEDIATEK INC., Hsin-Chu (TW)

(72) Inventors: Rui Zhang, San Jose, CA (US); Shiauhe Shawn Tsai, San Jose, CA (US); Jiaying Ren, San Jose, CA (US); Chiao-Yao Chuang, Hsinchu City (TW); Wenze Qu, Beijing (CN)

(73) Assignee: MEDIATEK INC., Hsin-Chu (TW)

(21) Appl. No.: 19/163,376

(22) PCT Filed: Mar. 14, 2024
(86) PCT No.: PCT/CN2024/081669

§ 371 Date: Sep. 8, 2025

Related U.S. Application Data
(60) Provisional application No. 63/490,017, filed on Mar. 14, 2023.

(30) Foreign Application Priority Data
Apr. 6, 2023 (WO) PCT/CN2023/086661
Apr. 25, 2023 (WO) PCT/CN2023/090587

(51) Int. Cl. H04W 72/0453; H04L 5/00

(52) U.S. Cl. CPC H04W 72/0453; H04L 5/0007

(57) ABSTRACT

A joint sensing method for an orthogonal frequency domain multiplexing (OFDM) communication system includes transmitting a plurality of reference signal (RS) resource elements (RE) from a set of staggering comb patterns to a sensing terminal; and determining the plurality of RS resource elements to perform either a full cycle of staggering, a partial cycle of staggering, or a combination of the full cycle and the partial cycle of staggering.

### CROSS REFERENCE TO RELATED APPLICATION

This application claims the benefit of U.S. Provisional Application No. 63/490,017, filed on Mar. 14, 2023. The content of the application is incorporated herein by reference.

### BACKGROUND OF THE INVENTION

### 1. Field of the Invention

The present invention relates to a joint sensing method and related user equipment for orthogonal frequency domain multiplexing communication system, and more particularly, to a joint sensing method and related user equipment for orthogonal frequency domain multiplexing communication system capable of improving radio resource efficiency.

### 2. Description of the Prior Art

The reference signal configuration is vital in conventional sensing performance when the orthogonal frequency domain multiplexing (OFDM) is applied to joint communication and sensing, especially for bi-static sensing. However, depending on the reference signal patterns, the ambiguity properties in delay (i.e., distance) and the Doppler frequency (i.e., velocity) domain are different. In addition, current positioning reference signal (PRS) is designed for single target positioning using conventional IFFT based algorithms.

### SUMMARY OF THE INVENTION

In light of this, the present invention provides a joint sensing method and related user equipment (UE) for an orthogonal frequency domain multiplexing (OFDM) communication system to improve ambiguity function characteristics associated with the RS pattern and algorithms, and utilize a full cycle of staggering, a partial cycle of staggering comb-based sensing reference signal patterns with super-resolution sensing algorithms.

An embodiment of the present invention provides a joint sensing method for an orthogonal frequency domain multiplexing (OFDM) communication system, comprises transmitting a plurality of reference signal (RS) resource elements (RE) from a set of staggering comb patterns to a sensing terminal; and determining the plurality of RS resource elements to perform either a full cycle of staggering, a partial cycle of staggering, or a combination of the full cycle and the partial cycle of staggering.

Another embodiment of the present invention provides a user equipment (UE) of an orthogonal frequency domain multiplexing (OFDM) communication system, comprises a wireless transceiver, configured to perform wireless transmission and reception to and from a service terminal; and a controller, configured to determine a plurality of RS resource elements to perform either a full cycle of staggering, a partial cycle of staggering, or a combination of the full cycle and the partial cycle of staggering.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication network according to an embodiment of the present invention.

FIGS. 2A, 2B, 2C are schematic diagrams of different staggering offset patterns of a comb structure according to an embodiment of the present invention.

FIG. 3 is a schematic diagram of a comb structure of RS pattern according to an embodiment of the present invention.

FIG. 4 is a schematic diagram of an example of different snapshots for comb-based RS symbols without staggering according to an embodiment of the present invention.

FIG. 5 is a schematic diagram of an example of ambiguity function of 2D MUSIC according to an embodiment of the present invention.

FIG. 6 is a schematic diagram of an example of snapshot for comb-based RS symbols according to an embodiment of the present invention.

FIGS. 7A, 7B are schematic diagrams of an example of ambiguity function according to an embodiment of the present invention.

FIGS. 8A, 8B are schematic diagrams of an example of ambiguity function according to an embodiment of the present invention.

FIG. 9 is a schematic diagram of an example of snapshot for comb-based RS symbols according to an embodiment of the present invention.

FIGS. 10A, 10B are schematic diagrams of an example of ambiguity function using 2D MUSIC according to an embodiment of the present invention.

FIGS. 11A, 11B are schematic diagrams of an example of ambiguity function using IAA according to an embodiment of the present invention.

FIGS. 12A, 12B, 12C and 12D are schematic diagrams of a comb structure of a reference signal (RS) pattern according to an embodiment of the present invention.

FIGS. 13A, 13B, 13C are schematic diagrams of instances of ambiguity properties of different staggering orders with a target at zero delay according to an embodiment of the present invention.

FIG. 14 is a schematic diagram of an example of different snapshots for comb-based RS symbols without staggering according to an embodiment of the present invention.

FIGS. 15A, 15B, 15C are schematic diagrams of ambiguity properties of staggering orders with a target at zero delay according to an embodiment of the present invention.

FIGS. 16A, 16B, 16C are schematic diagrams of results with a staggering order and a comb-4 structure with three targets according to an embodiment of the present invention.

### DETAILED DESCRIPTION

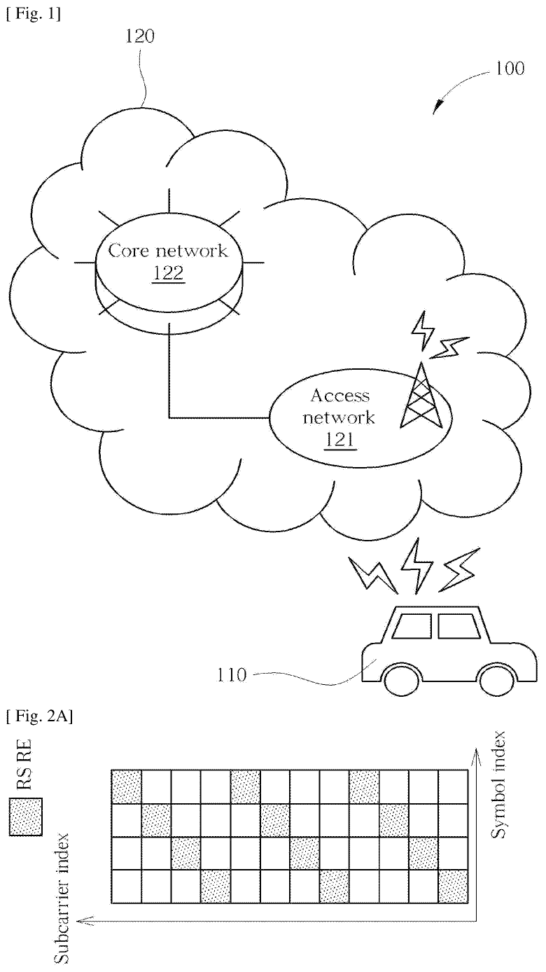

FIG. 1 is a schematic diagram of a wireless communication network 100 according to an embodiment of the present invention.

As shown in FIG. 1, the wireless communication network 100 may include a user equipment (UE) 110 and a service network 120, wherein the UE 110 may be wirelessly connected to the service network 120 for obtaining mobile services and performing cell measurements to the cell(s) of the service network 120.

The UE 110 may be a feature phone, a smartphone, a panel Personal Computer (PC), a laptop computer, a moving vehicle or any wireless communication device supporting the wireless technology (e.g., the 5G NR technology) utilized by the service network 120. In another embodiment, the UE 110 may support more than one wireless technology. For example, the UE may support the 5G NR technology and a legacy 4G technology, such as the LTE/LTE-A/TD-LTE technology.

The service network 120 includes an access network 121 and a core network 122. The access network 121 is responsible for processing radio signals, terminating radio protocols, and connecting the UE 110 with the core network 122. The core network 122 is responsible for performing mobility management, network-side authentication, and interfaces with public/external networks (e.g., the Internet). Each of the access network 121 and the core network 122 may comprise one or more network nodes for carrying out said functions.

In one embodiment, the service network 120 may be a 5G NR network, and the access network 121 may be a Radio Access Network (RAN) and the core network 122 may be a Next Generation Core Network (NG-CN).

A RAN may include one or more cellular stations, such as next generation NodeBs (gNBs), which support high frequency bands (e.g., above 24 GHZ), and each gNB may further include one or more Transmission Reception Points (TRPs), wherein each gNB or TRP may be referred to as a 5G cellular station. Some gNB functions may be distributed across different TRPs, while others may be centralized, leaving the flexibility and scope of specific deployments to fulfill the requirements for specific cases.

A 5G cellular station may form one or more cells with different Component Carriers (CCs) for providing mobile services to the UE 110. For example, the UE 110 may camp on one or more cells formed by one or more gNBs or TRPs, wherein the cells which the UE 110 is camped on may be referred to as serving cells, including a Primary cell (Pcell) and one or more Secondary cells (Scells).

An NG-CN generally consists of various network functions, including Access and Mobility Function (AMF), Session Management Function (SMF), Policy Control Function (PCF), Application Function (AF), Authentication Server Function (AUSF), User Plane Function (UPF), and User Data Management (UDM), wherein each network function may be implemented as a network element on a dedicated hardware, or as a software instance running on a dedicated hardware, or as a virtualized function instantiated on an appropriate platform, e.g., a cloud infrastructure.

The AMF provides UE-based authentication, authorization, mobility management, etc. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functions per session. The AF provides information on the packet flow to PCF responsible for policy control in order to support Quality of Service (QoS). Based on the information, the PCF determines policies about mobility and session management to make the AMF and the SMF operate properly. The AUSF stores data for authentication of UEs, while the UDM stores subscription data of UEs.

In another embodiment, the service network 120 may be an LTE/LTE-A/TD-LTE network, and the access network 121 may be an Evolved-Universal Terrestrial Radio Access Network (E-UTRAN) and the core network 122 may be an Evolved Packet Core (EPC).

An E-UTRAN may include at least one cellular station, such as an evolved NodeB (eNB) (e.g., macro eNB, femto eNB, or pico eNB), each of which may form a cell for providing mobile services to the UE 110. For example, the UE 110 may camp on one or more cells formed by one or more eNBs, wherein the cells which the UE 110 is camped on may be referred to as serving cells, including a Pcell and one or more Scells.

An EPC may include a Home Subscriber Server (HSS), Mobility Management Entity (MME), Serving Gateway (S-GW), and Packet Data Network Gateway (PDN-GW or P-GW).

It should be understood that the wireless communication network 100 described in the embodiment of FIG. 1 is for illustrative purposes and is not intended to limit the scope of the application. For example, the wireless communication network 100 may include both a 5G NR network and a legacy network (e.g., an LTE/LTE-A/TD-LTE network, or a WCDMA network), and the UE 110 may be wirelessly connected to both the 5G NR network and the legacy network.

An embodiment of the present invention derives the criteria of choosing reference signal patterns for super-resolution sensing algorithms, improves ambiguity function characteristics associated with such choice of RS pattern and algorithms and applies the derived principles to either new 6G joint communication sensing, or improvement over existing 5G NR, RS patterns.

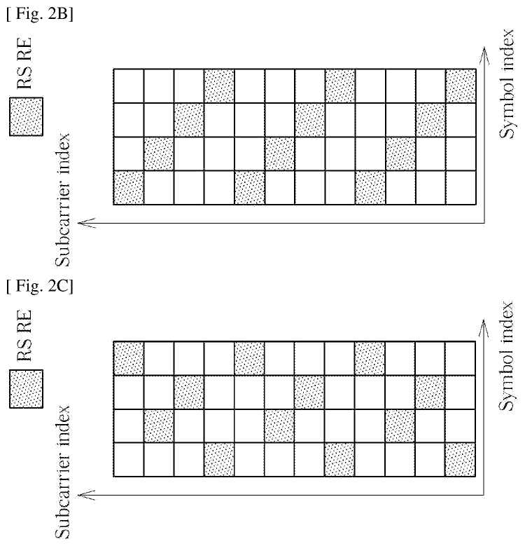

Please refer to FIGS. 2 (a), 2 (b), 2 (c), which are schematic diagrams of different staggering offset patterns of a comb structure according to an embodiment of the present invention. As shown in FIGS. 2 (a), 2 (b), 2 (c), the comb structure, i.e., comb-4, is to support a scenario that needs a high dynamic range, matched filter with frequency binnings may be adopted to the configurations of FIGS. 2 (a) and 2 (b), such that the scheme may support extended 2D unambiguous ranges.

On the other hand, the configuration shown in FIG. 2 (c) may be adopted with an extended 2D unambiguous ranges for delay and Doppler by slicing off some side peaks with lower power, which sacrifices the sensing dynamic range of detectable target signal strength. In addition, the super-resolution algorithms such as MUltiple SIgnal Classification and Iterative Adaptive Approach may show better unambiguous range in the case of FIG. 2 (c).

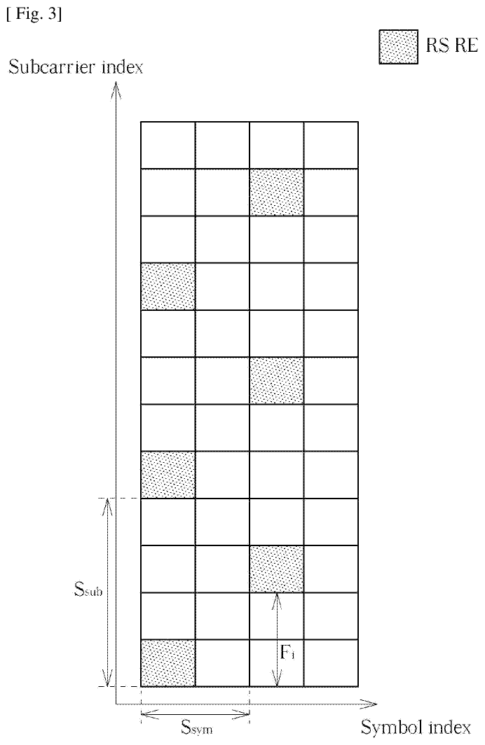

As shown in FIG. 3, let S_{sub} (unit in subcarrier numbers) be the spacing of the RS REs in frequency domain, and S_{sub}≥2 for comb structure, S_{sym} (unit in symbol numbers) be the spacing of the RS symbols in time domain, and the current positioning reference signal (PRS) adopts S_{sym}=1, Fᵢ (unit in subcarrier numbers) be the staggering offset in the frequency domain of the i-th RS symbol, Tₛ be OFDM duration, T_{cp} be CP duration, T=T_{cp}+Tₛ be the CP-added OFDM symbol duration. The RS patterns may be tuned by S_{sub}, S_{sym} and Fᵢ.

The RS patterns may be tuned by S_{sub}, S_{sym} and Fᵢ. For matched filter with frequency binnings and 2D FFT, staggering of different staggering offsets for different RS symbols may eliminate the time delay ambiguities in certain 2D ranges. Defining mod (Z, M)∈{0, 1, . . . . M−1} for any integers Z and M, where mod is modulo operation, two types of staggering formats as below are:

Staggering scheme A: staggering offset such that Fᵢ=mod (p·i+β₁, S_{sub}), where p is relative prime to S_{sub} and β₁∈{0, 1, . . . . S_{sub}−1}, i=0, 1, . . . .

Staggering scheme B: staggering offset such that there does not exist an integer pair (κ₁∈{1, 2, . . . , S_{sub}−1}, κ₂ ∈ [symbol] ) such that the following modulo equation system holds truemod (l κ₂−(F₁−F₀) κ₁, S_{sub})=0, for l=1, 2, . . . , i_{sym} U_{F}−1,

where i_{sym} ∈ [symbol] denotes the repetition times of a specific staggering pattern in one snapshot, U_{F} is the number of symbols number within the specific staggering pattern, l denotes the signal time duration in one snapshot, and Fₗ=F_{mod(l,U}_{_{F}}₎. In general, the anti-condition may be satisfied by κ₂=(F₁−F₀) κ₁ when the number of equations i_{sym} U_{F} is less than or equal to 2. Therefore, i_{sym}U_{F}≥3 is needed to guarantee the non-existence of the solution to the equation system.

One embodiment is to use the staggering order that is the same as PRS (U_{F}=S_{sub}) when S_{sub} is even and larger than 2, and

$${F}_{i} = \{ \begin{matrix}mod ( \frac{mod ( i , {S}_{sub} )}{2} + {β}_{2} , {S}_{sub} ) , i is even \\ mod ( {F}_{i - 1} + \frac{{S}_{sub}}{2} , {S}_{sub} ) , i is odd\end{matrix} ,$$

where β₂ is an integer∈{0, 1, 2, . . . S_{sub}−1}.

When S_{sub}=2, one embodiment is F₀=0, F₁=1, F₂=1, F₃=0 with U_{F}=4, i_{sym}=1.

In the following, RS configurations for different super-resolution sensing algorithms are described.

### MUSIC (MUltiple SIgnal Classification):

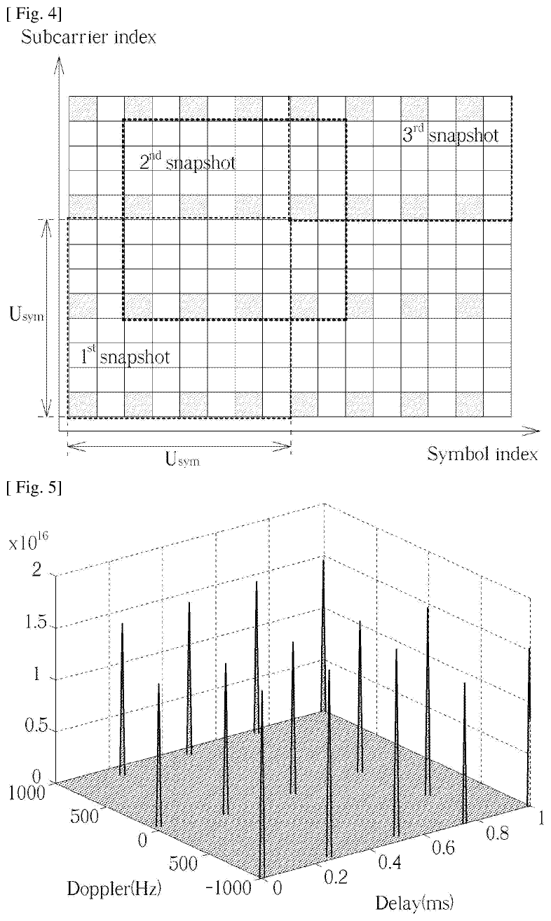

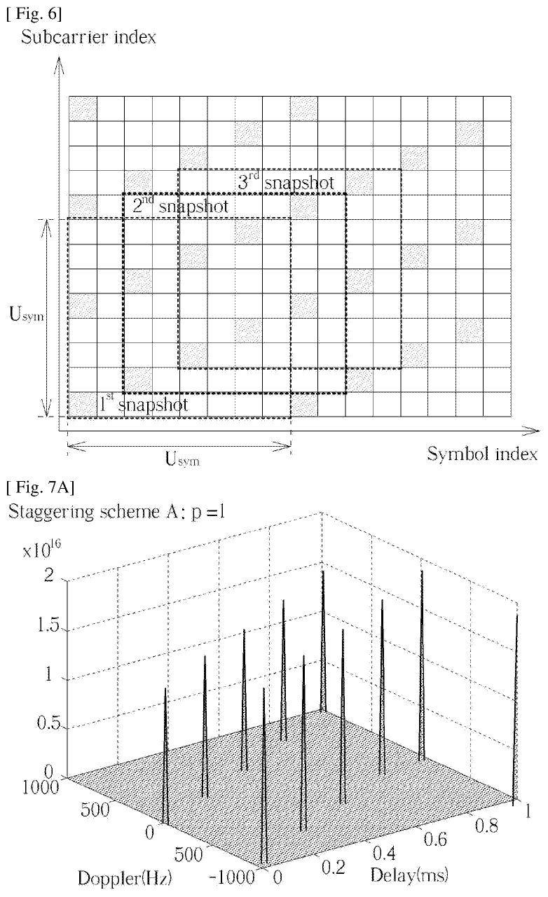

MUSIC is a super resolution sensing algorithm but requires multiple snapshots and shows relatively high complexity. The 2D MUSIC is employed for the comb structure in the frequency domain as shown in FIG. 4, FIG. 6, and FIG. 9. U_{sub} and U_{sym} are used to determine the occupied bandwidth and the time duration of each snapshot, respectively.

$${U}_{sub} = {i}_{sub} \cdot {S}_{sub} , where {i}_{sub} ∈ {ℤ}^{+} ,$$

$${U}_{sym} = {i}_{sym} \cdot {S}_{sym} \cdot {U}_{F}$$

where i_{sym} ∈ [symbol] denotes the repetition times of a specific staggering pattern in one snapshot, and U_{F} is the number of symbols within the specific staggering pattern.

FIG. 4 illustrates an instance of choosing each snapshot for comb-based RS symbols without staggering (U_{sub}=2S_{sub}, U_{sym}=4S_{sym}) where “spatial smoothing” is employed to avoid rank deficiency issues. In such case, U_{F}=1. The (m+1)-th snapshot will be shifted by mS_{sym} in symbol index and mS_{sub} in subcarrier index compared to the 1^{st} snapshot. For the (m+1)-th snapshot where m=0, 1, 2, . . . , (A)ₘ=BSₘ+Nₘ, where Nₘ is noise, (A)ₘ is a sequence of received non-zero RS REs without modulation in the m-th snapshot, B is the steering matrix needed to be estimated (does not change over snapshots), and Sₘ is the amplitude vector. In the case of FIG. 4, the h-th column of the steering matrix B may be written as:

$${b}_{h} = [ \begin{matrix}{e}^{- \frac{j 2 π 0 \cdot {S}_{sub} {τ}_{h}}{{T}_{s}}} {e}^{j 2 π 0 \cdot {S}_{sym} {Tf}_{h}} \\ {e}^{- \frac{j 2 π 1 \cdot {S}_{sub} {τ}_{h}}{{T}_{s}}} {e}^{j 2 π 0 \cdot {S}_{sym} {Tf}_{h}} \\ ⋮ \\ {e}^{- \frac{j 2 π ( {i}_{sub} - 1 ) {S}_{sub} {τ}_{h}}{{T}_{s}}} {e}^{j 2 π 0 \cdot {S}_{sym} {Tf}_{h}} \\ {e}^{- \frac{j 2 π 0 \cdot {S}_{sub} {τ}_{h}}{{T}_{s}}} {e}^{j 2 π 1 \cdot {S}_{sym} {Tf}_{h}} \\ {e}^{- \frac{j 2 π 1 \cdot {S}_{sub} {τ}_{h}}{{T}_{s}}} {e}^{j 2 π 1 \cdot {S}_{sym} {Tf}_{h}} \\ ⋮ \\ {e}^{- \frac{j 2 π ( {i}_{sub} - 1 ) {S}_{sub} {τ}_{h}}{{T}_{s}}} {e}^{j 2 π 1 \cdot {S}_{sym} {Tf}_{h}} \\ ⋮ \\ {e}^{- \frac{j 2 π 0 \cdot {S}_{sub} {τ}_{h}}{{T}_{s}}} {e}^{j 2 π ( {i}_{sym} - 1 ) \cdot {S}_{sym} {Tf}_{h}} \\ {e}^{- \frac{j 2 π 1 \cdot {S}_{sub} {τ}_{h}}{{T}_{s}}} {e}^{j 2 π ( {i}_{sym} - 1 ) \cdot {S}_{sym} {Tf}_{h}} \\ ⋮ \\ {e}^{- \frac{j 2 π ( {i}_{sub} - 1 ) {S}_{sub} {τ}_{h}}{{T}_{s}}} {e}^{j 2 π ( {i}_{sym} - 1 ) \cdot {S}_{sym} {Tf}_{h}}\end{matrix} ] ,$$

where H+1 is total target number, fₕ and τₕ are the Doppler frequency and time delay of the h-th target.

$${S}_{m} = [ \begin{matrix}{α}_{0} {e}^{j 2 π ( {mS}_{sym} ) {Tf}_{0}} {e}^{- \frac{j 2 π ( {mS}_{sub} ) {τ}_{0}}{{T}_{s}}} \\ ⋮ \\ {α}_{H} {e}^{j 2 π ( {mS}_{sym} ) {Tf}_{H}} {e}^{- \frac{j 2 π ( {mS}_{sub} ) {τ}_{H}}{{T}_{s}}}\end{matrix} ] ,$$

where αᵢ is the refection coefficients of the i-th target, m=0, 1, 2, . . .

$${( A )}_{m} = [ \begin{matrix}{A}_{{mS}_{sub} , {mS}_{sym}} \\ ⋮ \\ {A}_{( m + {i}_{sub} - 1 ) {S}_{sub} , {mS}_{sym}} \\ {A}_{{mS}_{sub} , ( m + 1 ) {S}_{sym}} \\ ⋮ \\ {A}_{( m + {i}_{sub} - 1 ) {S}_{sub} , ( m + 1 ) {S}_{sym}} \\ ⋮ \\ {A}_{{mS}_{sub} , ( m + {i}_{sym} - 1 ) {S}_{sym}} \\ ⋮ \\ {A}_{( m + {i}_{sub} - 1 ) {S}_{sub} , ( m + {i}_{sym} - 1 ) {S}_{sym}}\end{matrix} ] .$$

Observing steering matrix B, the ambiguities happen in the case of

$${τ}^{′} = τ + \frac{{k}_{1} {T}_{s}}{{S}_{sub}} , {f}^{′} = f + \frac{{k}_{2}}{{S}_{sym} T} ,$$

where τ and f are true delay and Doppler and (k₁, k₂) are integer pairs. FIG. 5 presents the ambiguity function of 2D MUSIC with (0, 0) as the true delay and Doppler pair in the case of S_{sym}=1, S_{sub}=4 without staggering.

FIG. 6 illustrates an instance of choosing each snapshot for comb-based RS symbols (U_{sub}=2S_{sub}, U_{sym}=S_{sub}S_{sym}, p=1, β₁=0) using staggering scheme A. “Spatial smoothing” is employed to avoid rank deficiency issues. In such case, U_{F}=S_{sub}. The (m+1)-th snapshot will be shifted by mS_{sym} in symbol index and

$$⌊ \frac{m}{{S}_{sub}} ⌋ \cdot {S}_{s u b} + {F}_{mod ( m , {S}_{sub} )}$$

in subcarrier index compared to the 1^{st} snapshot, where └·┘ is the round down operation. With a fixed number of snapshots, such case requires less REs than other cases. For the (m+1)-th snapshot, the h-th column of the steering matrix B is

$${b}_{h} = [ \begin{matrix}{e}^{- j ( \frac{2 π ( 0 \cdot {S}_{sub} + {F}_{0} )}{{T}_{s}} {τ}_{h} )} {e}^{j 2 π 0 \cdot {S}_{sym} {Tf}_{h}} \\ {e}^{- \frac{j 2 π ( 1 \cdot {S}_{sub} + {F}_{0} )}{{T}_{s}} {τ}_{h}} {e}^{j 2 π 0 \cdot {S}_{sym} {Tf}_{h}} \\ ⋮ \\ {e}^{- j ( \frac{2 π ( ( {i}_{sub} - 1 ) \cdot {S}_{sub} + {F}_{0} )}{{T}_{s}} {τ}_{h} )} {e}^{j 2 π 0 \cdot {S}_{sym} {Tf}_{h}} \\ {e}^{- j ( \frac{2 π ( 0 \cdot {S}_{sub} + {F}_{1} )}{{T}_{s}} {τ}_{h} )} {e}^{j 2 π 1 \cdot {S}_{sym} {Tf}_{h}} \\ {e}^{- \frac{j 2 π ( 1 \cdot {S}_{sub} + {F}_{1} )}{{T}_{s}} {τ}_{h}} {e}^{j 2 π 1 \cdot {S}_{sym} {Tf}_{h}} \\ ⋮ \\ {e}^{- j ( \frac{2 π ( ( {i}_{sub} - 1 ) \cdot {S}_{sub} + {F}_{1} )}{{T}_{s}} {τ}_{h} )} {e}^{j 2 π 1 \cdot {S}_{sym} {Tf}_{h}} \\ ⋮ \\ {e}^{- \frac{j 2 π ( 0 \cdot {S}_{sub} + {F}_{mod ( {i}_{sym} {S}_{sub} - 1 , {S}_{sub} )} )}{{T}_{s}} {τ}_{h}} {e}^{j 2 π ( {i}_{sym} {S}_{sub} - 1 ) \cdot {S}_{sym} {Tf}_{h}} \\ {e}^{- \frac{j 2 π ( 1 \cdot {S}_{sub} + {F}_{mod ( {i}_{sym} {S}_{sub} - 1 , {S}_{sub} )} )}{{T}_{s}} {τ}_{h}} {e}^{j 2 π ( {i}_{sym} {S}_{sub} - 1 ) \cdot {S}_{sym} {Tf}_{h}} \\ ⋮ \\ {e}^{- j ( \frac{2 π ( ( {i}_{sub} - 1 ) \cdot {S}_{sub} + {F}_{mod ( {i}_{sym} {S}_{sub} - 1 , {S}_{sub} )} )}{{T}_{s}} {τ}_{h} )} {e}^{j 2 π ( {i}_{sym} {S}_{sub} - 1 ) \cdot {S}_{sym} {Tf}_{h}}\end{matrix} ] ,$$

$$where h = 0 , 1 , … H .$$

$${S}_{m} = [ \begin{matrix}{α}_{0} {e}^{j 2 π ( {mS}_{sym} ) {Tf}_{0}} {e}^{- \frac{j 2 π {m ( ⌊ \frac{m}{{s}_{sum}} ⌋ \cdot {S}_{sub} + {F}_{mod ( m , {S}_{sub} )} )}^{{τ}_{0}}}{{T}_{s}}} \\ {α}_{H} {e}^{j 2 π ( {mS}_{sym} ) {Tf}_{H}} {e}^{- \frac{j 2 π {m ( ⌊ \frac{m}{{s}_{sub}} ⌋ \cdot {S}_{sub} + {F}_{mod ( m , {S}_{sub} )} )}^{{τ}_{H}}}{{T}_{s}}}\end{matrix} ] ,$$

$${( A )}_{m} = [ \begin{matrix}{A}_{( {mS}_{sub} + {F}_{0} ) , {mS}_{sym}} \\ ⋮ \\ {A}_{( m + {i}_{sub} - 1 ) {S}_{sub} + {F}_{0} , {mS}_{sym}} \\ {A}_{{mS}_{sub} + {F}_{1} , ( m + 1 ) {S}_{sym}} \\ ⋮ \\ {A}_{( m + {i}_{sub} - 1 ) {S}_{sub} + {F}_{1} , ( m + 1 ) {S}_{sym}} \\ ⋮ \\ {A}_{{mS}_{sub} + {F}_{mod ( {i}_{sym} {S}_{sub} - 1 , {S}_{sub} )} , ( m + {i}_{sym} {S}_{sub} - 1 ) {S}_{sym}} \\ ⋮ \\ {A}_{( m + {i}_{sub} + 1 ) {S}_{sub} + {F}_{mod ( {i}_{sym} {S}_{sub} - 1 , {S}_{sub} )} , ( m + {i}_{sym} {S}_{sub} - 1 ) {S}_{sym}}\end{matrix} ] .$$

When adopting the staggering scheme A, it may be concluded that the ambiguities happen at

$${τ}^{′} = τ + \frac{{k}_{1} {T}_{s}}{{S}_{sub}} , and {f}^{′} = f + \frac{{k}_{2}}{{S}_{sym} T} + \frac{{pk}_{1}}{{S}_{sub} {S}_{sym} T} ,$$

where (k₁, k₂) are integer pairs and τ and f are true delay and Doppler. For instance, when p=1, it may be concluded that the ambiguities happen at

$${τ}^{′} = τ + \frac{{k}_{1} {T}_{s}}{{S}_{sub}} , {f}^{′} = f + \frac{{k}_{2}}{{S}_{sym} T} + \frac{{k}_{1}}{{S}_{sub} {S}_{sym} T} ,$$

where (k₁, k₂) are integer pairs and τ and f are true delay and Doppler pair.

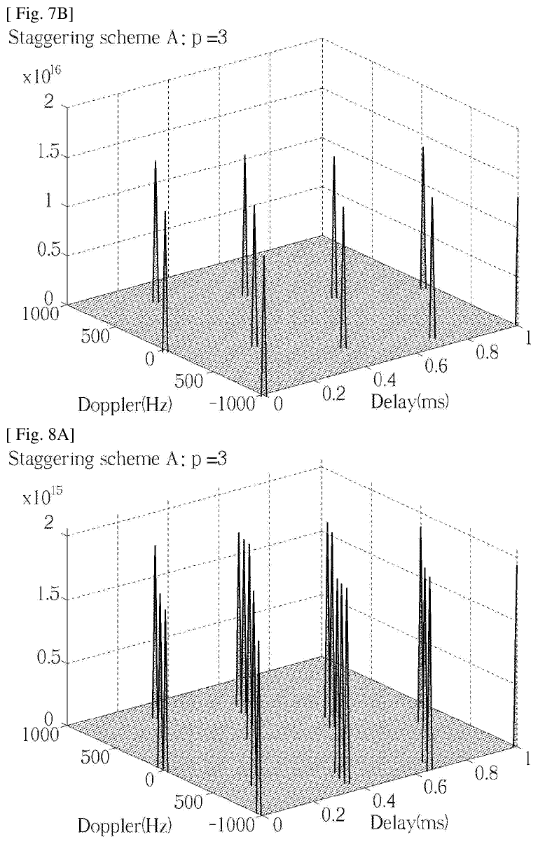

FIGS. 7 (a), 7 (b) illustrate ambiguity function with (0, 0) as the true delay and Doppler pair using 2D MUSIC in the case of S_{sym}=1, S_{sub}=4 with the staggering scheme A where FIG. 7 (a) shows the result of p=1 and FIG. 7 (b) shows the result of p=3.

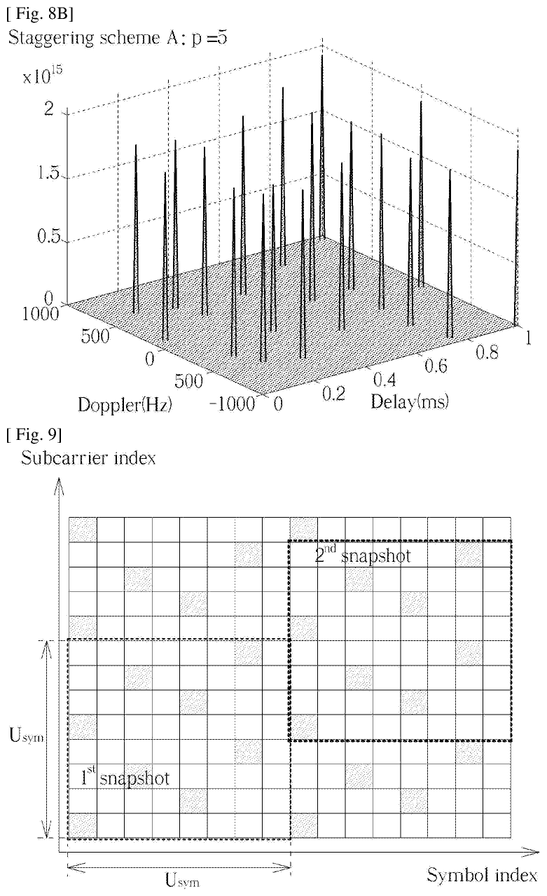

FIGS. 8 (a), 8 (b) illustrate ambiguity function of 2D MUSIC in the case of S_{sym}=1, S_{sub}=8 with the staggering scheme A, where FIG. 8 (a) shows the result of p=3 and FIG. 8 (b) shows the result of p=5.

FIG. 9 illustrates an instance of choosing each snapshot for comb-based RS symbols (U_{sub}=2S_{sub}, U_{sym}=S_{sub}S_{sym}, U_{F}=S_{sub}) using the staggering scheme B. “Spatial smoothing” is employed to avoid rank deficiency issues. In such case, U_{F} depends on the choices of the staggering pattern satisfying the aforementioned condition in the staggering scheme B. The (m+1)-th snapshot will be shifted by mU_{F}S_{sym} in symbol index and mS_{sub} in subcarrier index compared to the 1st snapshot. Therefore, with a fixed number of snapshots, such case requires more REs than other aforementioned cases. For the (m+1)-th snapshot, the h-th column of the steering matrix B is

$${b}_{h} = [ \begin{matrix}{e}^{- j ( \frac{2 π ( 0 \cdot {S}_{sub} + {F}_{0} )}{{T}_{s}} {τ}_{h} )} {e}^{j 2 π 0 \cdot {S}_{sym} {Tf}_{h}} \\ {e}^{- \frac{j 2 π ( 1 \cdot {S}_{sub} + {F}_{0} )}{{T}_{s}} {τ}_{h}} {e}^{j 2 π 0 \cdot {S}_{sym} {Tf}_{h}} \\ ⋮ \\ {e}^{- j ( \frac{2 π ( ( {i}_{sub} - 1 ) \cdot {S}_{sub} + {F}_{0} )}{{T}_{s}} {τ}_{h} )} {e}^{j 2 π 0 \cdot {S}_{sym} {Tf}_{h}} \\ {e}^{- j ( \frac{2 π ( 0 \cdot {S}_{sub} + {F}_{1} )}{{T}_{s}} {τ}_{h} )} {e}^{j 2 π 1 \cdot {S}_{sym} {Tf}_{h}} \\ {e}^{- \frac{j 2 π ( 1 \cdot {S}_{sub} + {F}_{1} )}{{T}_{s}} {τ}_{h}} {e}^{j 2 π 1 \cdot {S}_{sym} {Tf}_{h}} \\ ⋮ \\ {e}^{- j ( \frac{2 π ( ( {i}_{sub} - 1 ) \cdot {S}_{sub} + {F}_{1} )}{{T}_{s}} {τ}_{h} )} {e}^{j 2 π 1 \cdot {S}_{sym} {Tf}_{h}} \\ ⋮ \\ {e}^{- \frac{j 2 π ( 0 \cdot {S}_{sub} + {F}_{mod ( {i}_{sym} {U}_{F} - 1 , {U}_{F} )} )}{{T}_{s}} {τ}_{h}} {e}^{j 2 π ( {i}_{sym} {U}_{F} - 1 ) \cdot {S}_{sym} {Tf}_{h}} \\ {e}^{- \frac{j 2 π ( 1 \cdot {S}_{sub} + {F}_{mod ( {i}_{sym} {U}_{F} - 1 , {U}_{F} )} )}{{T}_{s}} {τ}_{h}} {e}^{j 2 π ( {i}_{sym} {U}_{F} - 1 ) \cdot {S}_{sym} {Tf}_{h}} \\ ⋮ \\ {e}^{- \frac{j 2 π ( ( {i}_{sub} - 1 ) \cdot {S}_{sub} + {F}_{mod ( {i}_{sym} {U}_{F} - 1 , {U}_{F} )} )}{{T}_{s}} {τ}_{h} )} {e}^{j 2 π ( {i}_{sym} {U}_{F} - 1 ) \cdot {S}_{sym} {Tf}_{h}}\end{matrix} ] ,$$

$$where h = 0 , 1 , … H .$$

Consider the matrices:

$${S}_{m} = [ \begin{matrix}{α}_{0} {e}^{j 2 π ( {mS}_{sym} {U}_{F} ) {Tf}_{0}} {e}^{- \frac{j 2 π {mS}_{sub} {τ}_{0}}{{T}_{s}}} \\ ⋮ \\ {α}_{H} {e}^{j 2 π ( {mS}_{sym} {U}_{F} ) {Tf}_{H}} {e}^{- \frac{j 2 π {mS}_{sub} {τ}_{H}}{{T}_{s}}}\end{matrix} ] ,$$

$${( A )}_{m} = [ \begin{matrix}{A}_{( {mS}_{sub} + {F}_{0} ) , {mU}_{sym} + 0 {S}_{sym}} \\ ⋮ \\ {A}_{( m + {i}_{sub} - 1 ) {S}_{sub} + {F}_{0} , {mU}_{sym} + {OS}_{sym}} \\ {A}_{{mS}_{sub} + {F}_{1} , {mU}_{sym} + 1 {S}_{sym}} \\ ⋮ \\ {A}_{( m + {i}_{sub} - 1 ) {S}_{sub} + {F}_{1} , {mU}_{sym} + 1 {S}_{sym}} \\ ⋮ \\ {A}_{{mS}_{sub} + {F}_{mod ( {i}_{sym} {U}_{F} - 1 , {U}_{F} )} , {mU}_{sym} + ( {i}_{sym} {U}_{F} - 1 ) {S}_{sym}} \\ ⋮ \\ {A}_{( m + {i}_{sub} - 1 ) {S}_{sub} + {F}_{mod ( {i}_{sym} {U}_{F} - 1 , {U}_{F} )} , {mU}_{sym} + ( {i}_{sym} {U}_{F} - 1 ) {S}_{sym}}\end{matrix} ] .$$

Note that the matrix B may not be distinguished between (τ, f) and

$$( {τ}^{′} = τ + {k}_{1} {T}_{s} , {f}^{′} = f + \frac{{k}_{2}}{{S}_{sym} T} )$$

for integer pair (k₁, k₂), regardless of the choices of staggering offset. For the staggering scheme B, ambiguities only happens at

$$( {τ}^{′} = τ + {k}_{1} {T}_{s} , {f}^{′} = f + \frac{{k}_{2}}{{S}_{sym} T} ) ,$$

which means that there are no side peaks within the range of time delay from 0 to Tₛ. This condition for side-peak non-existence may be met if and only if the following statement is true: there are no scalars τ′−τ∈(0, Tₛ) and f′−f ∈ [symbol] , such that the following equation (hereafter referred as “the anti-condition”) holds

$${e}^{- j ( \frac{2 π ( i \cdot {S}_{sub} + {F}_{l} )}{{T}_{s}} {τ}^{′} )} {e}^{j 2 π l \cdot {S}_{sym} {Tf}^{′}} = {e}^{- j ( \frac{2 π ( i \cdot {S}_{sub} + {F}_{l} )}{{T}_{s}} τ )} {e}^{j 2 π l \cdot {S}_{sym} Tf} ,$$

for all i=0, 1, . . . , i_{sub}−1, l=0, 1, . . . , i_{sym} U_{F}−1.

Note that above equation for the anti-condition may be equivalently re-written into the form:

$$l \cdot {S}_{sym} T ( {f}^{′} - f ) - \frac{( i \cdot {S}_{sub} + {F}_{l} )}{{T}_{s}} ( {τ}^{′} - τ ) = {κ}_{1}^{′} ,$$

where [symbol] is an arbitrary integer. Since the MUSIC algorithm is invariant to constant phase rotation, the staggering sequence {F₁} is equivalent to {F₁+β₂} for any β₂ ∈ [symbol] . Let F₀=0 without loss of generality. Then for l=0, the anti-condition is

$$\frac{( i \cdot {S}_{sub} )}{{T}_{s}} ( {τ}^{′} - τ ) = {κ}_{1}^{′} ,$$

which yields

$$( {τ}^{′} - τ ) = \frac{{κ}_{1} {T}_{s}}{{S}_{sub}} ,$$

where κ₁ is an arbitrary integer. By the assumption τ′-τ∈(0, Tₛ), it may have κ₁∈{1, 2, . . . , S_{sub}−1}. As a result, the staggering sequence {F₁} is equivalent to {mod (F₁+β₂, S_{sub})}, and it may be assumed that F₁∈{0, 1, . . . , S_{sub}−1} for any 1.

Considering the anti-condition with a general 1+0. The equation requires that

$$l \cdot {S}_{sym} T ( {f}^{′} - f ) - \frac{( i \cdot {S}_{sub} + {F}_{l} ) {κ}_{1}}{{S}_{sub}}$$

is an integer, and that

$$l \cdot {S}_{sym} T ( {f}^{′} - f ) - \frac{{F}_{l} {κ}_{1}}{{S}_{sub}}$$

is an integer. Thus, the condition is equivalent to lack of a solution (f′−f, κ₁) to the equation system

mod(1·S_{sym}S_{sub}T(f′−f)−F₁κ₁,S_{sub})=0, for l=1,2, . . . ,i_{sym}U_{F}−1.

Note that should a solution exist, the equation for 1=1 implies that the quantity S_{sym} S_{sub} T (f′−f) is an integer. Let us denote it as κ₂. When F₀=0, the condition is finally equivalently re-written as lack of a solution (κ₁∈{1, 2, . . . , S_{sub}−1}, κ₂ ∈ [symbol] ) to the equation system:

$$mod ( l {κ}_{2} - {F}_{l} {κ}_{1} , {S}_{sub} ) = 0 , for l = 1 , 2 , … , {i}_{sym} {U}_{F} - 1 ,$$

In general, constant phase rotation may be applied to {F₁}, and the equation system for the anti-condition becomes:

$$mod ( l {κ}_{2} - ( {F}_{l} - {F}_{0} ) {κ}_{1} , {S}_{s u b} ) = 0 , for l = 1 , 2 , … , {i}_{s y m} {U}_{F} - 1 .$$

When S_{sub} is prime, the only case where the condition does not hold is the staggering scheme A described above. Otherwise, one may construct desirable staggering schemes based on above condition. For example, when S_{sub} is even and larger than 2, one embodiment satisfying such condition is to use the staggering order that is the same as PRS.

$${F}_{i} = \{ \begin{matrix}mod ( \frac{mod ( i , {s}_{sub} )}{2} + {β}_{2} , {S}_{sub} ) , i is even \\ mod ( {F}_{i - 1} + \frac{{s}_{sub}}{2} , {S}_{sub} ) , i is odd\end{matrix} ,$$

where β2 is an integer∈{0, 1, 2, S_{sub}−1}.

In general, the anti-condition may be satisfied by κ₂=(F₁−F₀) κ₁ when the number of equations i_{sym} U_{F} is less or equal to 2. Therefore, i_{sym} U_{F}≥3 is needed to guarantee the non-existence of side peaks within the range.

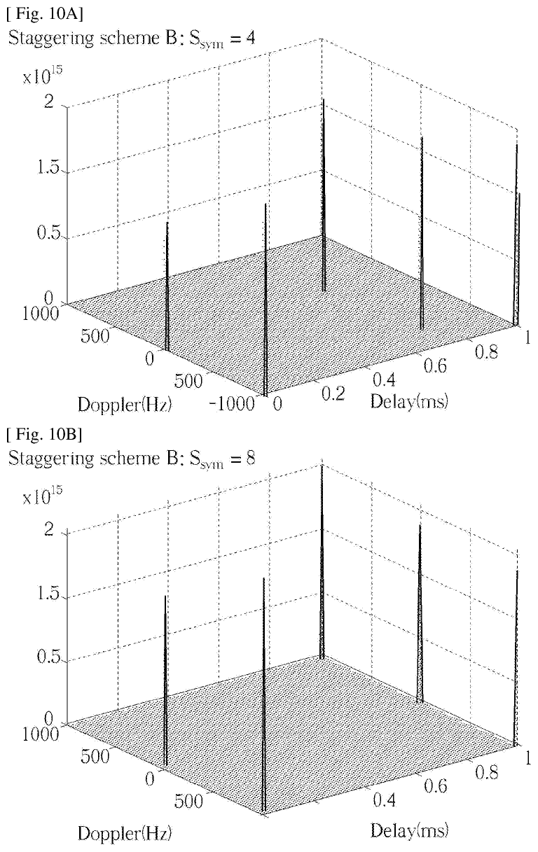

FIGS. 10 (a), 10 (b) show the ambiguity function with (0, 0) as the true delay and Doppler pair using 2D MUSIC in the cases of S_{sym}=1, S_{sub}=4 and S_{sym}=1, S_{sub}=8 with one embodiment of staggering scheme B, respectively.

The results indicated that the staggering scheme B with MUSIC gives the best 2D unambiguous range among all options. Depending on the application scenarios, the maximum unambiguous 2-D range around the main peak (0, 0) could have different options, which are time delay from 0 to Tₛ, Doppler frequency from I to

$$I + \frac{1}{{S}_{sym} T} ,$$

where I is a specified value and

$$- \frac{1}{{S}_{sym} T} \leq I \leq 0.$$

### IAA:

IAA is a super-resolution, on-grid algorithms which only requires a single snapshot. With a fixed number of REs, IAA may achieve better delay resolution and Doppler resolution than MUSIC, since no “spatial smoothing” and multiple snapshots are needed. The ambiguity properties corresponding to different RS configurations in the delay and Doppler domain show the same results as MUSIC. It formulates the sensing problem as V=WS+N, where

$$V = [ \begin{matrix}{A}_{{F}_{0} , 0} \\ ⋮ \\ {A}_{( K - 1 ) {S}_{sub} + {F}_{0} , 0} \\ {A}_{{F}_{1} , {S}_{sym}} \\ ⋮ \\ {A}_{( K - 1 ) {S}_{sub} + {F}_{1} , {S}_{sym}} \\ ⋮ \\ {A}_{{F}_{mod ( M - 1 , {U}_{F} )} , ( M - 1 ) {S}_{sym}} \\ ⋮ \\ {A}_{( K - 1 ) {S}_{sub} + {F}_{mod ( M - 1 , {U}_{F} )} , ( M - 1 ) {S}_{sym}}\end{matrix} ]$$

is the vectorized received non-zero RS REs without modulation, K∈ [symbol] determines the signal bandwidth, M determines the time duration, and

$$S = [ \begin{matrix}{α}_{0} \\ ⋮ \\ {α}_{G}\end{matrix} ] .$$

The h-th column of W may be written as

$${w}_{h} = [ \begin{matrix}{e}^{- \frac{j ( 2 π ( 0 \cdot {S}_{sub} + {F}_{0} ) {τ}_{h} )}{{T}_{s}}} {e}^{j 2 π 0 \cdot {S}_{sym} {Tf}_{h}} \\ {e}^{- \frac{j 2 π ( 1 \cdot {S}_{sub} + {F}_{0} ) {τ}_{h} )}{{T}_{s}}} {e}^{j 2 π 0 \cdot {S}_{sym} {Tf}_{h}} \\ ⋮ \\ {e}^{- \frac{j 2 π ( ( K - 1 ) \cdot {S}_{sub} + {F}_{0} ) {τ}_{h}}{{T}_{s}}} {e}^{j 2 π 0 \cdot {S}_{sym} {Tf}_{h}} \\ {e}^{- \frac{j ( 2 π ( 0 \cdot {S}_{sub} + {F}_{1} ) {τ}_{h} )}{{T}_{s}}} {e}^{j 2 π 1 \cdot {S}_{sym} {Tf}_{h}} \\ {e}^{- \frac{j 2 π ( 1 \cdot {S}_{sub} + {F}_{1} ) {τ}_{h} )}{{T}_{s}}} {e}^{j 2 π 1 \cdot {S}_{sym} {Tf}_{h}} \\ ⋮ \\ {e}^{- \frac{j 2 π ( ( K - 1 ) \cdot {S}_{sub} + {F}_{1} ) {τ}_{h}}{{T}_{s}}} {e}^{j 2 π 1 \cdot {S}_{sym} {Tf}_{h}} \\ ⋮ \\ {e}^{- \frac{j ( 2 π ( 0 \cdot {S}_{sub} + {F}_{mod ( M - 1 , {U}_{F} )} ) {τ}_{h} )}{{T}_{s}}} {e}^{j 2 π ( M - 1 ) \cdot {S}_{sym} {Tf}_{h}} \\ {e}^{- \frac{j ( 2 π ( 1 \cdot {S}_{sub} + {F}_{mod ( M - 1 , {U}_{F} )} ) {τ}_{h} )}{{T}_{s}}} {e}^{j 2 π ( M - 1 ) \cdot {S}_{sym} {Tf}_{h}} \\ ⋮ \\ {e}^{- \frac{j ( 2 π ( ( K - 1 ) \cdot {S}_{sub} + {F}_{mod ( M - 1 , {U}_{F} )} ) {τ}_{h} )}{{T}_{s}}} {e}^{j 2 π ( M - 1 ) \cdot {S}_{sym} {Tf}_{h}}\end{matrix} ]$$

where h denotes the h-th grid in the delay and Doppler domain, and h=0, 1, 2, . . . . G, where G denotes the grid density, larger G has denser grid in the resulted 2D ambiguity function. It may be observed that matrix W in IAA shows the same structure as matrix B of MUSIC. Therefore, the condition of the staggering scheme B presented in MUSIC section also hold true for IAA.

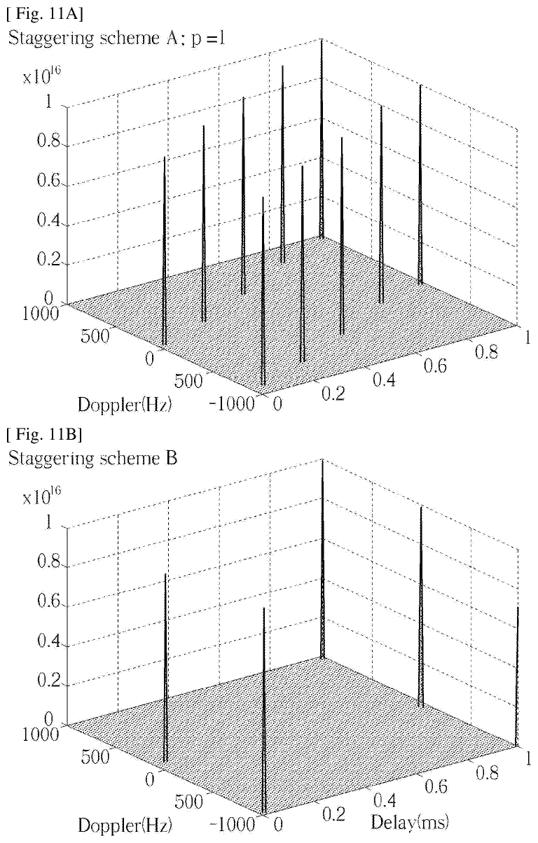

FIGS. 11 (a), 11 (b) illustrate several instances of the ambiguity functions using IAA in the case of S_{sub}=4, S_{sym}=1. Similarly, it may be concluded that the staggering scheme B with IAA (FIG. 11 (b)) gives the best 2D unambiguous range among all options. Depending on the application scenarios, the maximum unambiguous 2-D range around the main peak (0, 0) could have different options, which are time delay from 0 to Tₛ, Doppler frequency from I to

$$I + \frac{1}{{S}_{sym} T} ,$$

where I is a specified value and

$$- \frac{1}{{S}_{sym} T} \leq I \leq 0.$$

The above embodiments are analysis of radar sensing to detect both of Doppler and time delay detection. The following embodiments of multi-target positioning for different algorithms in the joint communication:

Traditional solutions for positioning in 5G NR did not consider adapting communication system RS patterns for desired ambiguity performances using super-resolution algorithms such as MUSIC and IAA. The present invention proposes methods of utilizing a full cycle of staggering, a partial cycle of staggering comb-based sensing reference signal patterns with super-resolution sensing algorithms for positioning or ranging.

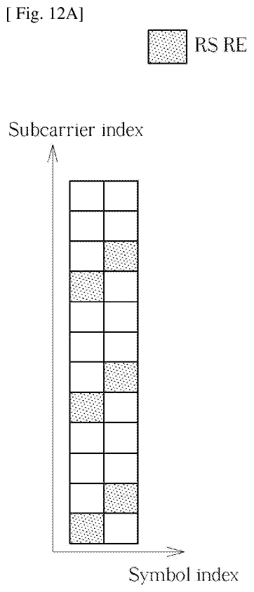

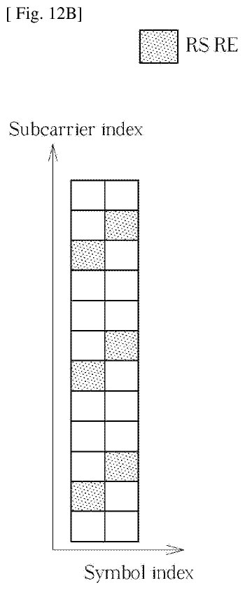

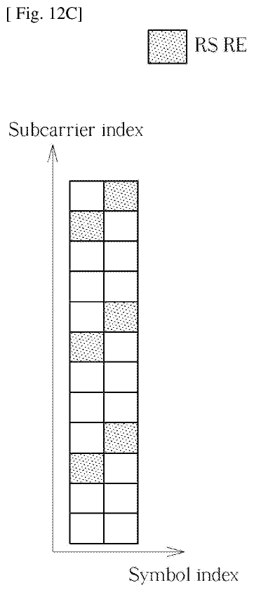

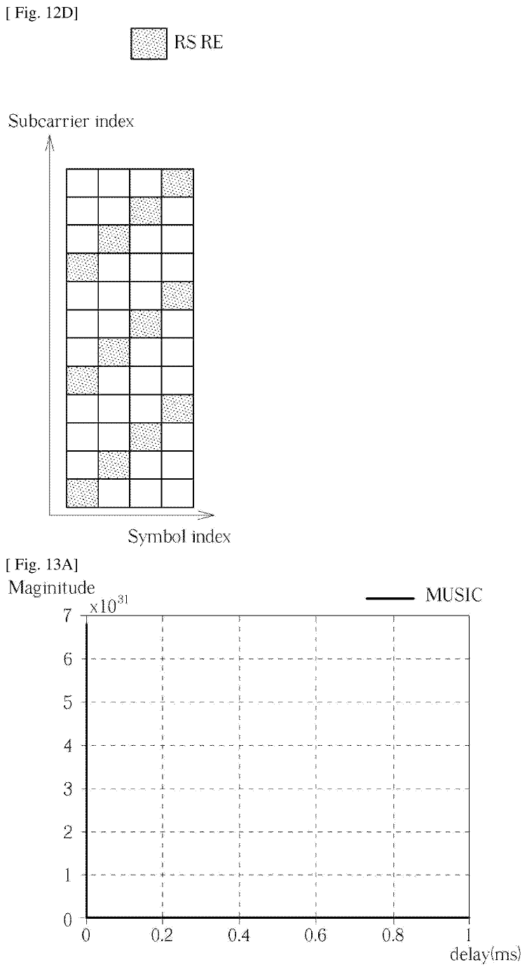

Please refer to FIGS. 12 (a), 12 (b), 12 (c), 12 (d), which are schematic diagrams of a comb structure of an RS pattern according to an embodiment of the present invention. The RS pattern includes a plurality of RS resource elements (RE).

An embodiment is to use a full cycle of staggering settings for the comb structure and a partial cycle of staggering in the comb structure (i.e., comb-4) as shown in FIGS. 12 (a), 12 (b), 12 (c), 12 (d), which may eliminate side peaks within the range of [0, Tₛ), where Tₛ is the OFDM symbol duration. Defining mod (Z, M)∈{0, 1, . . . . M−1} for any integers Z and M, where mod is modulo operation, and S_{sub} be the comb density.

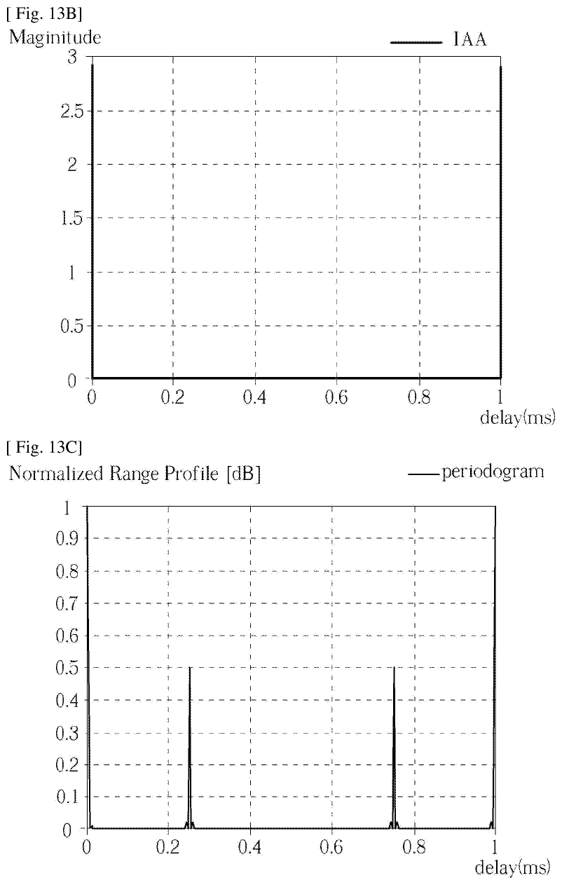

Overall, the staggering orders in FIGS. 12 (a), 12 (b), 12 (c) are instances of the partial cycle of staggering scheme: (mod(β₁, S_{sub}), mod (β₁+1, S_{sub})), where β₁=0, 1, . . . , S_{sub}−1, which are the subset of the staggering order (mod(β, S_{sub}), mod (β+1, S_{sub}), . . . mod (β+S_{sub}−1, S_{sub})), where β=0, 1, . . . , S_{sub}−1, as shown in FIG. 12 (d). FIGS. 12 (a), 12 (b), 12 (c), 12 (d) present instances of the ambiguity properties (Tₛ=1 ms) of staggering orders (mod(β₁, S_{sub}), mod (β₁+1, S_{sub})) with a target at zero delay, and the side peaks within the range of [0, Tₛ) may be eliminated using super-resolution algorithms such as MUltiple SIgnal Classification (MUSIC) or Iterative Adaptive Approach (IAA) in FIGS. 13 (a) and 13 (b). FIG. 13 (c) shows the result of the FFT based algorithm.

As shown in FIG. 3, let S_{sub} (unit in subcarrier numbers) be the spacing of the RS REs in frequency domain, and S_{sub}≥2 for comb structure, S_{sym} (unit in symbol numbers) be the spacing of the RS symbols in time domain, and the current positioning reference signal (PRS) adopts S_{sym}=1, Fᵢ (unit in subcarrier numbers) be the staggering offset in the frequency domain of the i-th RS symbol, Tₛ be OFDM duration, T_{cp} be CP duration, T=T_{cp}+Tₛ be the CP-added OFDM symbol duration. The RS patterns may be tuned by S_{sub}, S_{sym} and Fᵢ.

Defining mod (Z, M)∈{0, 1, . . . . M−1} for any integers Z and M, where mod is modulo operation, the staggering formats with staggering offset are denoted, such that no integer (κ₁∈{1, 2, . . . , S_{sub}−1}) exists for the following modulo equation system to be true (i.e. the anti-condition):

$$mod ( ( {F}_{l} - {F}_{0} ) {κ}_{1} , {S}_{sub} ) = 0 , for l = 1 , 2 , … , {U}_{F} - 1.$$

where U_{F} is the number of symbols number, l is the symbol index, and Fᵢ∈{0, 1, 2, . . . , S_{sub}−1}.

In general, the anti-condition may be satisfied by U_{F}=2, F₁−F₀ and is a relative prime to S_{sub}. An embodiment is U_{F}=2, F₁−F₀=1, which eliminates the side peaks in the delay domain.

### MUSIC (MUltiple SIgnal Classification):

MUSIC may be employed for the comb structure in the frequency domain as shown in FIG. 4. U_{sub} and U_{sym} determine the occupied bandwidth and the coherent time duration of each snapshot, respectively, as follows:

$${U}_{sub} = {i}_{sub} \cdot {S}_{sub} , where {i}_{sub} ∈ {ℤ}^{+} ,$$

$${U}_{sym} = {S}_{sym} \cdot {U}_{F}$$

where U_{F} is the number of RS symbols in one snapshot.

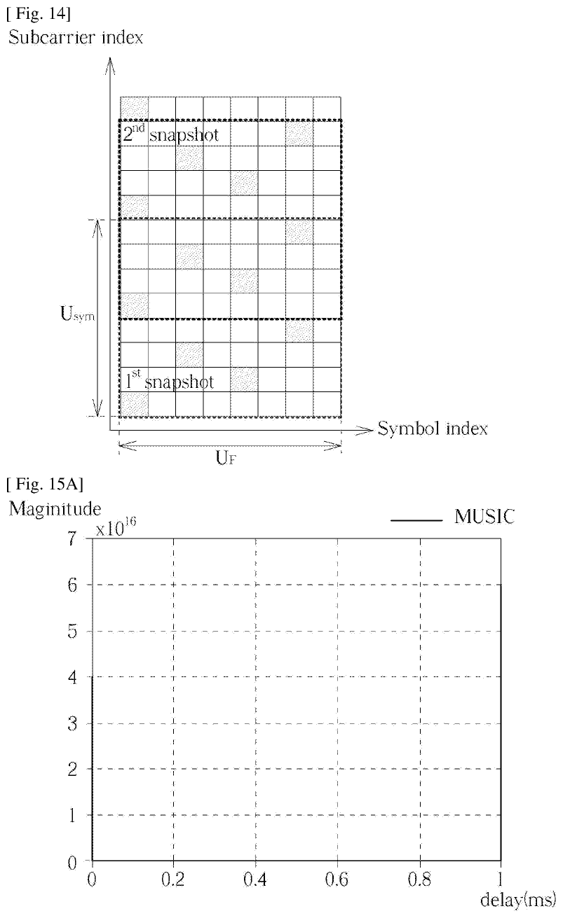

FIG. 14 illustrates an instance of choosing each snapshot for comb-based RS symbols (U_{sub}=2S_{Sub}, U_{F}=S_{sub}, S_{sym}=2). “Spatial smoothing” is employed to avoid rank deficiency issues. For the (m+1)-th snapshot where m=0, 1, 2, . . . (A)ₘ=BSₘ+Nₘ, where Nₘ is noise, (A)ₘ is a sequence of received non-zero RS REs without modulation in the m-th snapshot, B is the steering matrix needed to be estimated (does not change over snapshots), and Sₘ is the amplitude vector. The (m+1)-th snapshot will be shifted by S_{sub} in subcarrier index compared to the m-th snapshot. For the (m+1)-th snapshot, the h-th column of the steering matrix B is

$$[ \begin{matrix}{e}^{- j ( \frac{2 π ( 0 \cdot {S}_{sub} + {F}_{0} )}{{T}_{s}} {τ}_{h} )} \\ {e}^{- j \frac{j 2 π ( 1 \cdot {S}_{sub} + {F}_{0} )}{{T}_{s}} {τ}_{h} )} \\ ⋮ \\ {e}^{- j ( \frac{2 π ( ( {i}_{sub} - 1 ) \cdot {S}_{sub} + {F}_{0} )}{{T}_{s}} {τ}_{h} )} \\ {e}^{- j ( \frac{2 π ( 0 \cdot {S}_{sub} + {F}_{1} )}{{T}_{s}} {τ}_{h} )} \\ {e}^{- \frac{j 2 π ( 1 \cdot {S}_{sub} + {F}_{1} )}{{T}_{s}} {τ}_{h}} \\ ⋮ \\ {e}^{- j ( \frac{2 π ( ( {i}_{sub} - 1 ) \cdot {S}_{sub} + {F}_{1} )}{{T}_{s}} {τ}_{h} )} \\ ⋮ \\ {e}^{- \frac{j 2 π ( 0 \cdot {S}_{sub} + {F}_{{U}_{F} - 1} )}{{T}_{s}} {τ}_{h}} \\ {e}^{- \frac{j 2 π ( 1 \cdot {S}_{sub} + {F}_{{U}_{F} - 1} )}{{T}_{s}} {τ}_{h}} \\ ⋮ \\ {e}^{- j ( \frac{2 π ( ( {i}_{sub} - 1 ) \cdot {S}_{sub} + {F}_{{U}_{F} - 1} )}{{T}_{s}} {τ}_{h} )}\end{matrix} ] , where h = 0 , 1 , … H .$$

$${S}_{m} = [ \begin{matrix}{α}_{0} {e}^{- \frac{j 2 π m ( {S}_{sub} ) {τ}_{0}}{{T}_{s}}} \\ ⋮ \\ {α}_{H} {e}^{- \frac{j 2 π m ( {S}_{sub} ) {τ}_{H}}{{T}_{s}}}\end{matrix} ] , {( A )}_{m} = [ \begin{matrix}{A}_{( {mS}_{sub} + {F}_{0} ) , {OS}_{sym}} \\ ⋮ \\ {A}_{( m + {i}_{sub} - 1 ) {S}_{sub} + {F}_{0} , 0 {S}_{sym}} \\ {A}_{{mS}_{sub} + {F}_{1} , {S}_{sym}} \\ ⋮ \\ {A}_{( m + {i}_{sub} - 1 ) {S}_{sub} + {F}_{1} , {S}_{sym}} \\ ⋮ \\ {A}_{{mS}_{sub} + {F}_{{U}_{F} - 1} , ( {U}_{F} - 1 ) {S}_{sym}} \\ ⋮ \\ {A}_{( m + {i}_{sub} - 1 ) {S}_{sub} + {F}_{{U}_{F} - 1} , ( {U}_{F} - 1 ) {S}_{sym}}\end{matrix} ] .$$

Note that the matrix B may not be distinguished between τ and τ′=τ+κ₁Tₛ for a non-zero integer κ₁, regardless of the choices of staggering offset. For the proposed staggering scheme, ambiguities may only happen at τ′=τ+κ₁Tₛ, which means that there are no side peaks within the range of time delay from 0 to Tₛ. This condition for side-peak non-existence may be met if and only if the following statement is true: there are no scalars τ′−τ∈(0, Tₛ), such that the following equation (hereafter referred as “the anti-condition”) may hold:

$${e}^{- j ( \frac{2 π ( i \cdot {S}_{sub} + {F}_{l} )}{{T}_{s}} {τ}^{′} )} = {e}^{- j ( \frac{2 π ( i \cdot {S}_{sub} + {F}_{l} )}{{T}_{s}} τ )} ,$$

for all i=0, 1, . . . , i_{sub}−1, l=0, 1, . . . , U_{F}−1. Note that above equation for the anti-condition may be equivalently re-written into the form:

$$\frac{( i \cdot {S}_{sub} + {F}_{l} )}{{T}_{s}} ( {τ}^{′} - τ ) = {κ}_{1}^{′} ,$$

where κ′₁ is an arbitrary integer.

Since the MUSIC algorithm is invariant to constant phase rotation, the staggering sequence {F₁} is equivalent to {F₁+β₂} for any β₂∈Z. Therefore, F₀=0 is assumed without loss of generality. Then for l=0, the anti-condition is

$$\frac{( i \cdot {S}_{s u b} )}{{T}_{s}} ( {τ}^{′} - τ ) = {κ}_{1}^{′} ,$$

which yields

$$( {τ}^{′} - τ ) = \frac{{κ}_{1} {T}_{s}}{{S}_{sub}} ,$$

where κ₁ is an arbitrary integer. By the assumption τ′−τ∈(0, Tₛ) κ₁∈{1, 2, . . . , S_{sub}−1}, the staggering sequence {F₁} is equivalent to {mod (F₁+β₂, S_{sub})}, and F₁∈{0, 1, . . . , S_{sub}−1} for any 1. And the anti-condition is with a general l≠0. The equation requires that

$$\frac{( i \cdot {S}_{sub} + {F}_{l} ) {κ}_{1}}{{S}_{sub}}$$

is an integer, and that

$$\frac{{F}_{l} {κ}_{1}}{{S}_{sub}}$$

is an integer. Thus, when F₀=0, the condition is equivalent to lack of a solution κ₁ to the equation system: mod (F₁κ₁, S_{sub})=0, for l=1, 2, . . . , U_{F}−1.

In general, a constant phase rotation may be applied to {F₁}, and the equation system for the anti-condition becomes mod ((F₁−F₀) κ₁, S_{sub})=0, for l=1, 2, . . . , U_{F}−1. In general, the anti-condition may be satisfied by U_{F}=2, F₁−F₀ is a relative prime to S_{sub}.

### IAA:

IAA is a super-resolution, on-grid algorithms which only requires a single snapshot. With a fixed number of REs, IAA may achieve better delay resolution and Doppler resolution than MUSIC since no “spatial smoothing” and multiple snapshots are needed. Its ambiguity properties of different RS configurations in the delay and Doppler domain shows the same results as MUSIC. The sensing problem is formulated as V=WS+N, where

$$V = [ \begin{matrix}{A}_{{F}_{0} , 0} \\ ⋮ \\ {A}_{( K - 1 ) {S}_{sub} + {F}_{0} , 0} \\ {A}_{{F}_{1} , {S}_{sym}} \\ ⋮ \\ {A}_{( K - 1 ) {S}_{sub} + {F}_{1} , {S}_{sym}} \\ ⋮ \\ {A}_{{F}_{{U}_{F}} , ( {U}_{F} - 1 ) {S}_{sym}} \\ ⋮ \\ {A}_{( K - 1 ) {S}_{sub} + {F}_{{U}_{F}} , ( {U}_{F} - 1 ) {S}_{sym}}\end{matrix} ]$$

is the vectorized received non-zero RS REs without modulation, K∈ [symbol] ⁺ determines the signal bandwidth, and

$$S = [ \begin{matrix}{α}_{0} \\ ⋮ \\ {α}_{G}\end{matrix} ] .$$

The h-th column of W may be written as

$${w}_{h} = [ \begin{matrix}{e}^{- \frac{j ( 2 π ( 0 \cdot {S}_{sub} + {F}_{0} ) {τ}_{h} )}{{T}_{s}}} \\ {e}^{- \frac{j 2 π ( 1 \cdot {S}_{sub} + {F}_{0} ) {τ}_{h} )}{{T}_{s}}} \\ ⋮ \\ {e}^{- \frac{j 2 π ( ( K - 1 ) \cdot {S}_{sub} + {F}_{0} ) {τ}_{h} )}{{T}_{s}}} \\ {e}^{- \frac{j ( 2 π ( 0 \cdot {S}_{sub} + {F}_{1} ) {τ}_{h} )}{{T}_{s}}} \\ {e}^{- \frac{j 2 π ( 1 \cdot {S}_{sub} + {F}_{1} ) {τ}_{h}}{{T}_{s}}} \\ ⋮ \\ {e}^{- \frac{j 2 π ( ( K - 1 ) \cdot {S}_{sub} + {F}_{1} ) {τ}_{h}}{{T}_{s}}} \\ ⋮ \\ {e}^{- \frac{j ( 2 π ( 0 \cdot {S}_{sub} + {F}_{{U}_{F} - 1} ) {τ}_{h} )}{{T}_{s}}} \\ {e}^{- \frac{j ( 2 π ( 1 \cdot {S}_{sub} + {F}_{{U}_{F} - 1} ) {τ}_{h} )}{{T}_{s}}} \\ ⋮ \\ {e}^{- \frac{j ( 2 π ( ( K - 1 ) \cdot {S}_{sub} + {F}_{{U}_{F} - 1} ) {τ}_{h} )}{{T}_{s}}}\end{matrix} ]$$

where h denotes the where h denotes the h-th grid in the delay and Doppler domain, and h=0, 1, 2, . . . . G, where G denotes the grid density, larger G has denser grid. The matrix W in IAA shows the same structure as matrix B of MUSIC. Therefore, the condition of the proposed staggering scheme presented in MUSIC section also hold true for IAA.

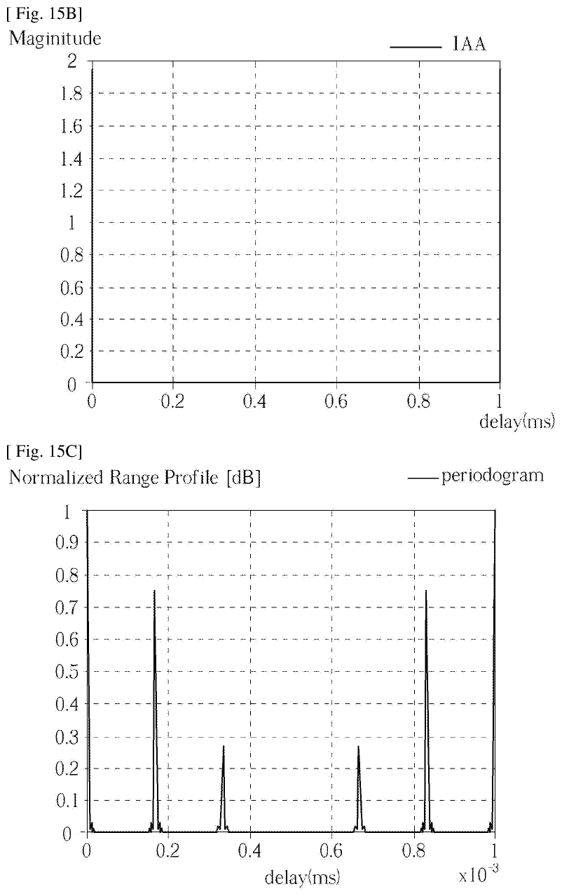

FIGS. 15 (a), 15 (b), 15 (c) show another instance of the ambiguity properties (T_{S}=1 ms, S_{sub}=6) of staggering orders (mod(β₁, S_{sub}), mod (β₁+1, S_{sub})) with a target at zero delay, and again it may be observed that the side peaks within the range of [0, T_{S}) may be eliminated using super-resolution algorithms such as MUSIC or IAA in FIGS. 15 (a) and 15 (b). FIG. 15 (c) shows the result using IFFT.

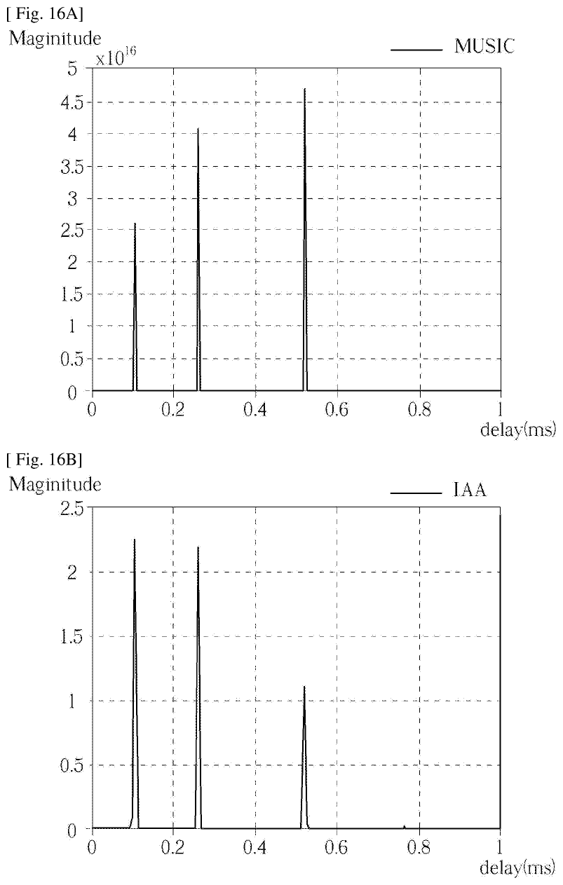

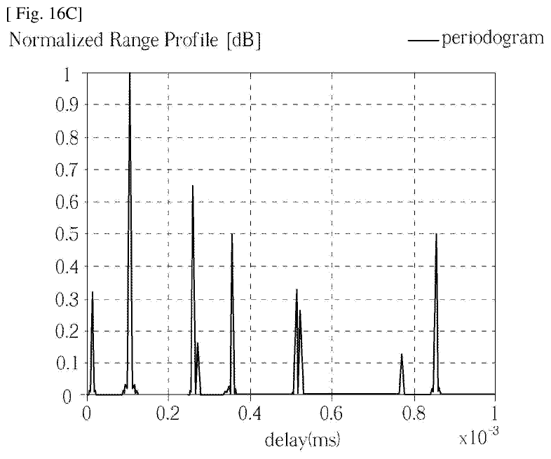

FIGS. 16 (a), 16 (b), 16 (c) show the results using the proposed staggering order (mod(β₁, S_{sub}), mod (β₁+1, S_{sub})) and comb 4 structure with three targets (time delays are 0.1042 ms, 0.2604 ms, 0.5208 ms, respectively). MUSIC and IAA may distinguish multiple targets successfully as shown in FIGS. 16 (a) and 16 (b), while IFFT (i.e., FIG. 16 (c)) shows worse ambiguity performance. Moreover, the proposed staggering scheme may be easily multiplexed by tuning the offset β1 and β or finding staggering patterns satisfying the lack of solution to the aforementioned modulo equation.

Notably, those skilled in the art may properly design the joint communication and sensing method and the UE according to different system requirements, which are not limited thereto.

In summary, the present invention provides a joint sensing method and related user equipment (UE) for an orthogonal frequency domain multiplexing (OFDM) communication system, which improves ambiguity function characteristics associated with the RS pattern and algorithms, and utilizes a full cycle of staggering, a partial cycle of staggering comb-based sensing reference signal patterns using super-resolution sensing algorithms.

Those skilled in the art will readily observe that numerous modifications and alterations of the device and method may be made while retaining the teachings of the invention. Accordingly, the above disclosure should be construed as limited only by the metes and bounds of the appended claims.

1. A joint sensing method for an orthogonal frequency domain multiplexing (OFDM) communication system, comprising:
transmitting a plurality of reference signal (RS) resource elements (RE) from a set of staggering comb patterns to a sensing terminal; and
determining the plurality of RS resource elements to perform either a full cycle of staggering, a partial cycle of staggering, or a combination of the full cycle and the partial cycle of staggering.

2. The joint sensing method of claim 1, wherein the reference signal has a staggering pattern with a sequence of a plurality of staggering offsets, each of the plurality of staggering offsets multiplied by a plurality of positive integers smaller than a comb density, modulo a comb size, are all non-zeros.

3. The joint sensing method of claim 1, wherein S_{sub} unit in a subcarrier number denotes a spacing of a plurality of non-zero resource elements (RE) in a frequency domain, S_{sym} unit in a symbol number denotes the spacing of the RS symbol in the time domain, Fᵢ unit in a subcarrier numbers denotes a staggering offset in the frequency domain of an iₜₕ RS symbol, Tₛ denotes an OFDM duration, T_{cp} denotes a cyclic prefix (CP) duration, and T=T_{S}+T_{cp} denotes a sum of the OFDM symbol duration and the CP duration.

4. The joint sensing method of claim 3, wherein a plurality of side peaks with a range of 0 to Tₛ is eliminated with a super-resolution algorithm.

5. The joint sensing method of claim 3, wherein a 2D multiple signal classification (MUSIC) for the staggering comb pattern in a frequency domain, a spatial smoothing is employed to avoid rank deficiency.

6. The joint sensing method of claim 5, wherein a maximum unambiguous 2D range around a main peak are time delay from 0 to Tₛ, Doppler frequency from l to
$$I + \frac{1}{{S}_{sym} T} ,$$
where I is a specified value and
$$- \frac{1}{{S}_{sym} T} \leq I \leq 0.$$

7. The joint sensing method of claim 5, wherein a plurality of snapshots are utilized for the MUSIC.

8. The joint sensing method of claim 7, wherein an occupied bandwidth is determined according to a repetition time of a staggering pattern in one snapshot of the plurality of snapshots and a number of reference symbols within the staggering pattern.

9. The joint sensing method of claim 3, wherein a single snapshot of a staggering pattern is utilized for an IAA super-resolution, on-grid algorithm with a fixed number of REs without spatial smoothing.

10. The joint sensing method of claim 9, wherein a maximum unambiguous 2D range around a main peak are time delay from 0 to Ts, Doppler frequency from I to
$$I + \frac{1}{{S}_{sym} T} ,$$
where I is a specified value and
$$- \frac{1}{{S}_{sym} T} \leq I \leq 0.$$

11. A user equipment (UE) of an orthogonal frequency domain multiplexing (OFDM) communication system, comprising:
a wireless transceiver, configured to perform wireless transmission and reception to and from a service terminal; and
a controller, configured to determine a plurality of RS resource elements to perform either a full cycle of staggering, a partial cycle of staggering, or a combination of the full cycle and the partial cycle of staggering.

12. The UE of an OFDM communication system of claim 11, wherein the reference signal has a staggering pattern with a sequence of a plurality of staggering offsets, each of the plurality of staggering offsets multiplied by a plurality of positive integers smaller than a comb density, modulo a comb size, are all non-zeros.

13. The UE of an OFDM communication system of claim 11, wherein S_{sub} unit in a subcarrier number denotes a spacing of a plurality of non-zero resource elements (RE) in a frequency domain, S_{sym} unit in a symbol number denotes the spacing of the RS symbol in the time domain, Fᵢ unit in a subcarrier numbers denotes a staggering offset in the frequency domain of an iₜₕ RS symbol, Tₛ denotes an OFDM duration, T_{cp} denotes a cyclic prefix (CP) duration, and T=T_{S}+T_{cp} denotes a sum of the OFDM symbol duration and the CP duration.

14. The UE of an OFDM communication system of claim 13, wherein a plurality of side peaks with a range of 0 to Tₛ is eliminated with a super-resolution algorithm.

15. The UE of an OFDM communication system of claim 13, wherein a 2D multiple signal classification (MUSIC) for the staggering comb pattern in a frequency domain, a spatial smoothing is employed to avoid rank deficiency.

16. The UE of an OFDM communication system of claim 15, wherein a maximum unambiguous 2D range around a main peak are time delay from 0 to Ts, Doppler frequency from I to
$$I + \frac{1}{{S}_{sym} T} ,$$
where I is a specified value and
$$- \frac{1}{{S}_{sym} T} \leq I \leq 0.$$

17. The UE of an OFDM communication system of claim 15, wherein a plurality of snapshots are utilized for the MUSIC.

18. The UE of an OFDM communication system of claim 17, wherein an occupied bandwidth is determined according to a repetition time of a staggering pattern in one snapshot of the plurality of snapshots and a number of reference symbols within the staggering pattern.

19. The UE of an OFDM communication system of claim 13, wherein a single snapshot of a staggering pattern is utilized for an IAA super-resolution, on-grid algorithm with a fixed number of REs without spatial smoothing.

20. The UE of an OFDM communication system of claim 19, wherein a maximum unambiguous 2D range around a main peak are time delay from 0 to Ts, Doppler frequency from I to
$$I + \frac{1}{{S}_{sym} T} ,$$
where I is a specified value and
$$- \frac{1}{{S}_{sym} T} \leq I \leq 0.$$
